(19) United States
(12) Patent Application Publication
(10) Pub. No.: US 2006/0136345 A1
(43) Pub. Date: Jun. 22, 2006

(54) Efficient schema supporting upsell features of a web-based business application

(75) Inventors: Jeffrey A. Jones, Larkspur, CA (US); Jingwei Liang, Castro Valley, CA (US)

Correspondence Address: BRIAN J. DAIUTO, 886 ILIMA COURT, PALO ALTO, CA, 94306, US

(73) Assignee: NETSUITE, INC., SAN MATEO, CA (US)

(21) Appl. No.: 11/148,466

(22) Filed: Jun. 9, 2005

Related U.S. Application Data
(63) Continuation-in-part of application No. 11/016,087, filed on Dec. 17, 2004.

(51) Int. Cl. G06F 17/00

(52) U.S. Cl. 705/402

(57) ABSTRACT

An efficient schema and related methods, systems, computer program products, and business methods are described for supporting upsell features of a web-based business application. A single database of the web-based business application can support a plurality of enterprises, each enterprise selling its respective items to its respective customers. As transactions are received, transaction information including an enterprise identifier, a customer identifier, and one or more item identifiers is stored across at least two tables in the database including a first table and a second table. At predetermined intervals the first and second tables are processed to compute third and fourth tables comprising precomputed values from which upsell information requests can be readily accommodated. Accordingly, despite substantial volumes of transaction information being received by the database across multiple enterprises, a response to an upsell information request for a particular enterprise can provided quickly while also being generally up-to-date.

### CROSS-REFERENCE TO RELATED APPLICATIONS

This is a continuation-in-part of U.S. patent application Ser. No. 11/016,087, entitled “Web-Based Business Application With Streamlined Integration Of Upsell Features,” filed Dec. 17, 2004, which is assigned to the assignee of the present invention, and which is incorporated by reference herein.

### FIELD

This patent specification relates to web-based business applications. More particularly, this patent specification relates to an efficient database schema and associated computational methods for supporting upsell features of a web-based business application.

### BACKGROUND

Successful, sustainable business enterprises often use cross-selling and up-selling as important components of their sales and marketing strategies. Although usage of these terms can vary among different environments, cross-selling usually refers to marketing new products to current customers based on their past purchases, while up-selling usually refers to moving customers from less profitable items in a category to more profitable items in the same category. In both cases, knowledge relating to a first set of items (e.g., past purchases, a currently contemplated purchase, a currently known opportunity, etc.) is leveraged for identifying a second set of items (e.g., complementary items, more lucrative items, etc.) to sell. For clarity of presentation, the term “upsell” is used herein to broadly reference the practice of identifying a second set of sales possibilities based on a first set of realized or unrealized sales possibilities. Thus, for example, in addition to encompassing the above cross-selling and up-selling activities, “upselling” also refers herein to identifying current customers likely to buy a particular item (e.g., an overstocked item), finding items that an identified customer is more likely to buy, and identifying a second set of items likely to be purchased in conjunction with a first set of items. As used herein, “item” refers broadly to anything that can be sold, including goods, services, rights, warranties, etc.

The ability of business users to manage crucial business information has been greatly enhanced by the proliferation of IP-based networking together with advances in object oriented Web-based programming and browser technology. Using these advancements, systems have been developed that permit web-based access to business information systems, thereby allowing any user with a browser and an Internet or intranet connection to view, enter, or modify the required business information.

As used herein, the term web-based business application or web-based business information system generally refers to a business software system having browser-based access such that an end user requires only a browser and an Internet/intranet connection on their desktop, laptop, network appliance, PDA, etc., to obtain substantially complete access to that system. Examples of web-based business applications include those described in the commonly assigned US2004/0199541A1, US2004/0199543A1, U.S. Ser. No. 10/796,718, and U.S. Ser. No. 10/890,347, each of which is incorporated by reference herein. Further examples of web-based business applications include application service provider (ASP) hosted services provided by NetSuite, Inc. of San Mateo, Calif. such as NetSuite™, NetSuite™ Small Business, NetCRM™, NetERP™, NetCommerce™, and NetFlex™, descriptions of which can be found at www.netsuite.com. A further example of a web-based business application is discussed at www.salesforce.com. Web-based business applications can also be implemented using non-ASP models having different hosting mechanisms, such as with self-hosted systems in which a business enterprise operates and maintains its own private, captive business information system having browser-based access across an intranet and/or the Internet.

A commercial enterprise can achieve many functional and strategic advantages by using a web-based business information system comprising integrated ERP (Enterprise Resource Planning), CRM (Customer Relationship Management), and other business capabilities. Because substantially all of the enterprise's business information is in one place, including sales histories, inventory levels, and customer profitability data, substantial advantages can be enjoyed by mining that data to achieve profitable business insights.

Problems can arise in properly integrating data mining tools into a practical web-based business application environment. The success of a web-based business application hinges not only on the availability of powerful capabilities, but also on whether these capabilities are placed within the practical, everyday grasp of end users. The additional capabilities should be perceived as tools that readily resolve existing problems, that readily integrate into the existing workflow, and that make existing life easier, rather than harder, for the end user. End users should want to use the tools. One particularly sensitive issue associated with user perception of any web-based tool is whether the response time to user requests (i.e., the interval between pressing the “go” or “send” button and the time the requested information is displayed) is sufficiently brief. Other business issues related to the success of the web-based business application are concurrently implicated, such as hardware and software implementation costs for the ASP or other system host.

Accordingly, in a web-based business information system, it would be desirable to facilitate rapid system responses to upsell information queries from end users of an enterprise.

It would be further desirable to so facilitate such rapid responses in a manner that does not appreciably hinder transactional information flows into and out of a database associated with that enterprise.

It would be still further desirable to facilitate such rapid system responses in an environment in which multiple enterprises are served by a single database, for facilitating control of implementation costs. Other issues arise as would be apparent to one skilled in the art upon reading the present disclosure.

### SUMMARY

An efficient schema and related methods, systems, computer program products, and business methods are described for supporting upsell features of a web-based business application, such as that described in Ser. No. 11/016,087, supra. In one preferred embodiment, a method for facilitating upselling in a web-based business application used by an enterprise is provided, the enterprise having a plurality of customers, the enterprise executing one or more transactions with each customer in which one or more items is sold. For each transaction, a customer identifier is received at a database server, along with an item identifier for each item sold in that transaction. The database server stores the transaction information across at least two tables including a first table and a second table. At predetermined intervals of generally long duration compared to intervals between the executed transactions, third and fourth tables are computed from the first and second tables. The third table summarizes, for each item, a number of customers having purchased that item from the enterprise. The fourth table summarizes, for each possible pairing of items, a number of customers having purchased both members of that pair of items from the enterprise. Upon receiving an upsell information request at the database server for a plurality of pairwise, customerwise correlation metrics between an upsell item sold by the enterprise and each other item sold by the enterprise, that plurality of pairwise, customerwise correlation metrics is computed in real time using the third and fourth tables.

In another preferred embodiment, a method for facilitating upselling in a web-based business application used by a plurality of enterprises is provided. Each enterprise has a plurality of customers, and each enterprise executes one or more transactions with each customer in which one or more items is sold. For each of the transactions, a client input is received. The client input communicates an enterprise ID and a customer ID associated with each transaction, and further communicates an item ID for each item sold in that transaction. The enterprise ID, the customer ID, and a transaction key reference are stored in a single record of a first table of a database, that database being common to at least two of the enterprises, including that enterprise for which the transaction information is currently being stored. In a second table of that database, the transaction key reference and each of the item IDs for each transaction is stored across a number of records corresponding to a number of items sold in that transaction. At predetermined intervals, the first and second tables of the database are processed to compute third and fourth tables thereof. The third table summarizes, for each enterprise and for each item sold by that enterprise, a first count of customers having purchased that item from that enterprise. The fourth table summarizes, for each enterprise and each possible pairing of items sold by that enterprise, a second count of customers having purchased both items from the enterprise. An upsell information request is received identifying a first enterprise associated with the database and identifying an upsell item. Responsive to that upsell information request, a plurality of pairwise, customerwise correlation metrics between the upsell item and each other item sold by the first enterprise is computed, the computing being performed in real time using the third and fourth tables of the database previously computed at the predetermined intervals. While also accommodating the volumes of transaction information and other requests being received by the database across the multiple enterprises, the response to the upsell information request for the particular enterprise is quickly provided while also being generally up-to-date.

### BRIEF DESCRIPTION OF THE DRAWINGS

FIG. 1 illustrates a conceptual diagram of a computer network including an enterprise network and a web-based business information system according to a preferred embodiment;

FIG. 2 illustrates a hierarchical network diagram of the web-based business information system of FIG. 1;

FIG. 3 illustrates transaction information tables of a database according to a preferred embodiment;

FIG. 4 illustrates populating transaction information tables and count summary tables of a database according to a preferred embodiment;

FIG. 5 illustrates count summary tables of a database according to a preferred embodiment; and

FIGS. 6-7 illustrate receiving and responding to upsell information requests according to a preferred embodiment.

### DETAILED DESCRIPTION

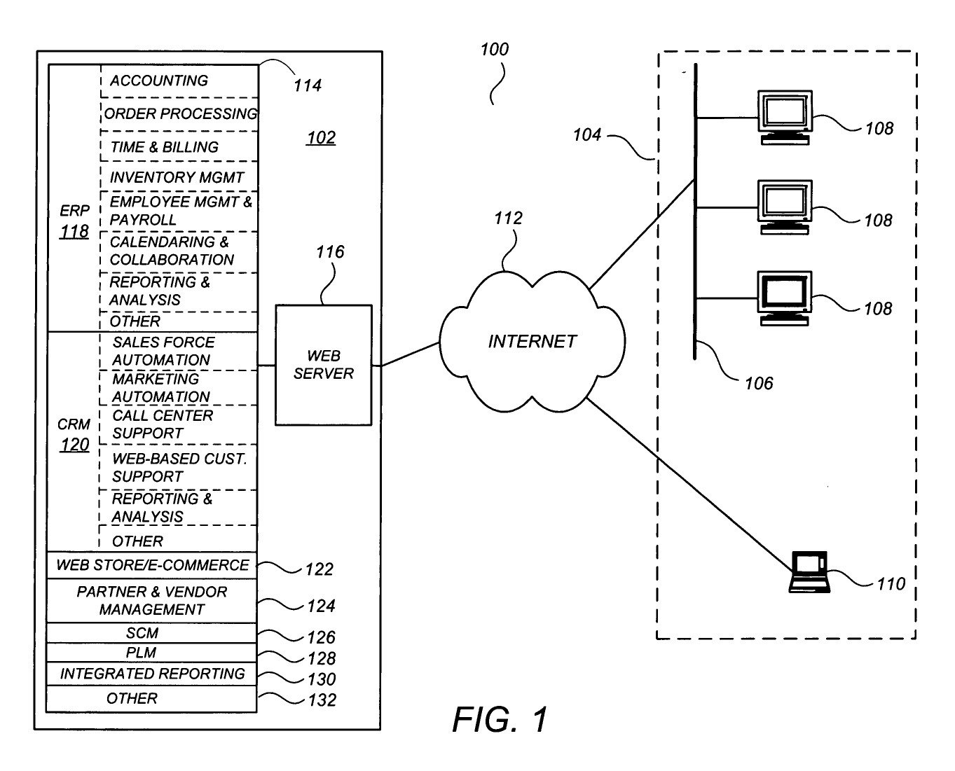

FIG. 1 illustrates a conceptual diagram of a network 100 including a web-based business application 102 and an enterprise network 104 into which the features and advantages of one or more preferred embodiments may be realized. Enterprise network 104 is associated generally with a business enterprise that may be as small as a single-employee sole proprietorship or as large as a multinational corporation having many different facilities and internal networks spread across many continents. Alternatively, and in accordance with the advantages of an application service provider (ASP) model, the business enterprise may comprise no dedicated facilities or business network at all, provided that its end users have access to an internet browser and an internet connection. For simplicity and clarity of explanation, the enterprise network 104 is simply represented by an on-site local area network 106 to which a plurality of personal computers 108 is connected, each generally dedicated to a particular end user although such dedication is not required, along with an exemplary remote user computer 110 that can be, for example, a laptop computer of a traveling employee having internet access through a hotel, coffee shop, a public Wi-Fi access point, or other internet access modality. The end users associated with computers 108 and 110 may also each possess a personal digital assistant (PDA) such as a Blackberry, Palm, Handspring, or other PDA unit having wireless internet access and/or cradle-based synchronization capabilities. Users of the enterprise network 104 interface with the web-based business application 102 across the Internet 112.

Web-based business application 102, which in this example is a dedicated third party ASP, comprises an integrated business server 114 and a web server 116 coupled as shown in FIG. 1. Integrated business server 114 comprises an ERP functionality as represented by ERP module 118, and further comprises a CRM functionality as represented by CRM module 120. It is to be appreciated that identification herein of business functionalities with modules does not limit the scope of the preferred embodiments to segregated units thereof. In many preferred embodiments the ERP module 118 may share methods, libraries, databases, subroutines, variables, etc., with CRM module 120, and indeed ERP module 118 may be intertwined with CRM module 120 into a larger integrated code set without departing from the scope of the preferred embodiments.

In a preferred embodiment similar to NetSuite, supra, the ERP module 118 comprises an accounting module, an order processing module, a time and billing module, an inventory management module, an employee management and payroll module, a calendaring and collaboration module, a reporting and analysis module, and other ERP-related modules. The CRM module 120 comprises a sales force automation (SFA) module, a marketing automation module, a contact list module (not shown), a call center support module, a web-based customer support module, a reporting and analysis module, and other CRM-related modules. The integrated business server further 114 further provides other business functionalities including a web store/e-commerce module 122, a partner and vendor management module 124, and an integrated reporting module 130. These functionalities are preferably integrated and executed by a single code base accessing one or more integrated databases as necessary. In another preferred embodiment, an SCM module 126 and PLM module 128 is provided. Web server 116 is configured and adapted to interface with the integrated business server 114 to provide web-based user interfaces to end users of the enterprise network 104. Version 10.0 of the NetSuite™ product line, on public sale by NetSuite, Inc. of San Mateo, Calif. as of September 2004, represents one example of a web-based business application with streamlined integration of upsell features according one or more of the preferred embodiments described herein.

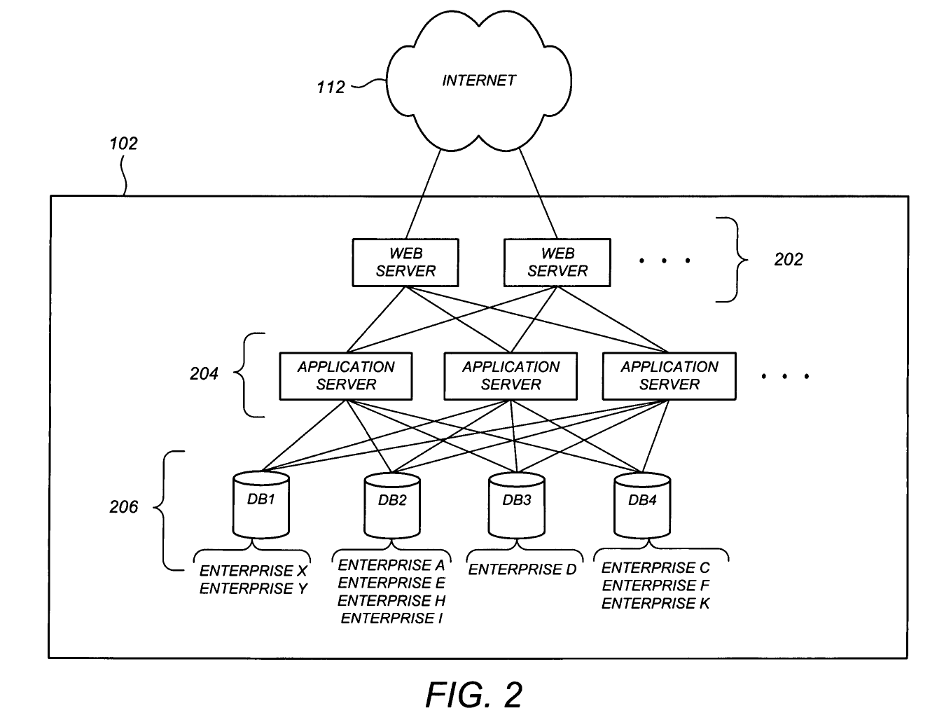

FIG. 2 illustrates a hierarchical network diagram of the web-based business information system 102 of FIG. 1 more closely reflecting one ASP-hosted implementation thereof that, while being particularly advantageous in many respects, brings about one or more issues that are at least partially resolved in accordance with one or more described embodiments herein. Shown in place of the single web server 116 of FIG. 1 is a common set of web servers 202 that are substantial duplicates of each other. The web servers 202 can run conventional web server software, such as Apache, Microsoft-IIS, Netscape-Enterprise, Oracle HTTP Server, etc. on conventional operating systems such Linux, Solaris, Unix, HP-UX, FreeBSD, etc. loaded onto conventional web server hardware. The web servers 202 receive user requests that are submitted via the web browsers running on the computers 108/110 of the end users, and transmit appropriately-formatted web pages to achieve the desired web-based user interfaces as described in Ser. No. 11/016,087, supra. In one preferred embodiment, the web-based user interfaces are compatible with newer versions of Microsoft Internet Explorer, AOL Netscape Navigator, Mozilla FireFox, etc. that support style sheets, scripting, JavaScript 1.5 and higher, and Dynamic HTML (DHTML).

Web-based business information system 102 further comprises a plurality of application servers 204 that are also substantial duplicates of each other. Web-based business information system further comprises a plurality of database servers 206. As used herein, database server is used to refer to both the data volumes themselves upon which the enterprise information is stored as well as the DBMS (database management system) used to query and manipulate that data. In the ASP-hosted implementation of FIG. 2, each different enterprise (or “account”) is associated with one of the database servers 206. Furthermore, several different enterprises can be serviced by one database server as indicated in FIG. 2. Each of the application servers 204 is programmed to serve client requests sent to the web servers 202 and, in conjunction with the appropriate one of database servers 206, is programmed to carry out the functionalities described supra in relation to the integrated business server 114 of FIG. 1 for each enterprise. Protocols that may be used to facilitate inter-server communications include smbXML and qbXML. Application servers 204 may use, for example, Oracle Application Server Containers for J2EE (OC4J) or other appropriate system.

As known in the art, one difference between the web servers 202 and the application servers 204 is that the web servers 202 are commonly associated with faster, lighter, lower-level processing tasks such as the establishment and tearing down of TCP connections, forwarding of HTTP requests to the application servers, forwarding of HTTP responses from the application servers, etc., in accordance with the overall purpose of Apache, Microsoft-IIS and the like. In contrast, the application servers 204 are commonly associated with more time-intensive tasks such as interpreting client requests, requesting database manipulations at the database servers 206, waiting for responses from the database servers 206, and generating and formatting web page responses to the client requests, in accordance with the overall purpose of OC4J and the like. The database servers 206 perform SQL-based database operations that can range from very fast to very slow depending on the nature of the requested operation, the amount of data involved, and the volume of different operations being requested.

The web-based business information system 202 represents a so-called three-tiered server architecture, comprising a first tier of web servers, a second tier of application servers, and a third tier of database servers. Advantages of the architecture of FIG. 2 include modularity that makes it easier to modify or replace one tier without affecting the other tiers. Also, separating the application server functions from the database server functions makes it easier to implement load balancing, whereby the different groupings of enterprises can be migrated to different database servers 206 as loads evolve without requiring modifications at the application server or web server levels.

It is to be appreciated that the scope of the preferred embodiments is not limited to scenarios in which the web-based business information system 102 is an integration of many different business functionalities. In other preferred embodiments, the web-based business information system 102 may have a single business management functionality, e.g., it may consist only of an SFA system, or only of a vendor management system. In still other preferred embodiments, the web-based business information system 102 may comprise different combinations of these functionalities. It is to be further appreciated that the lines in FIG. 2 between the web servers 202 and application servers 204, as well as between the application servers 204 and the databases 206, are only shown to indicate potential data communication pairings among these elements, and do not necessarily represent physical connections among these hardware elements. Rather, as known in the art, in most implementations the various hardware elements are connected via a packet-switched LAN or WAN. It is to be further appreciated that the various hardware components illustrated in FIG. 2 do not need to be located in the same room, the same building, the same city, or even the same continent, provided that they are in networked connectivity to achieve an architecture analogous to that of FIG. 2.

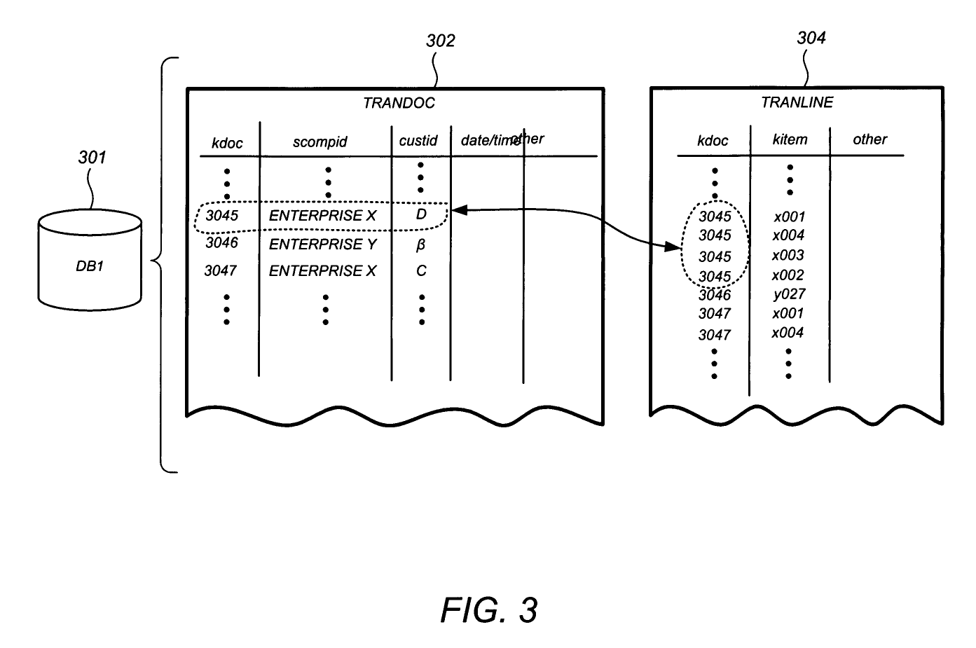

FIG. 3 illustrates transaction information tables of a database 301 according to a preferred embodiment. The database 301 may correspond, for example, to one of the database servers 206 of FIG. 2, representing the particular data storage volumes and schema related thereto. In the particular example of FIG. 3, the database 301 is associated with two or more enterprises, including an enterprise “X” and an enterprise “Y”. Database 301 comprises a first table (TRANDOC table 302) and a second table (TRANLINE table 304) for storing the bulk of the transaction information associated with all enterprises (“accounts”) that are assigned to the database 301. TRANDOC table 302 comprises a plurality of fields including a transaction ID field (not shown), a transaction key reference field (kdoc), an enterprise ID field (scompid), a customer ID field (custid), a date/time field, and a variety of other fields whose contents are beyond the scope of the present disclosure. For each transaction, the transaction ID field (not shown) uniquely identifies that transaction, and is generally a very long alphanumeric string. The transaction key reference field (kdoc) represents a successive location in the TRANDOC table 302, is generally shorter than the transaction ID field, and serves as a foreign key reference into the TRANDOC table 302 for other tables in the database 301. According to a preferred embodiment, the TRANDOC table 302 comprises a single row (record) for any particular transaction, regardless of the number of items that were sold in that transaction.

The TRANLINE table 304 comprises a transaction key reference field (kdoc) that serves as a foreign key reference into the TRANDOC table 302, an item ID field (kitem), and a variety of other fields whose contents are beyond the scope of the present disclosure. According to a preferred embodiment, the TRANLINE table 304 comprises one record per item sold in each transaction, and therefore comprises a number of records per transaction equal to the number of items sold in that transaction. Illustrated by way of example in FIG. 3 is a particular transaction between enterprise X and one if its customers “D”, having a transaction key reference 3045 in the single associated record of the TRANDOC table 302. Correspondingly, the TRANLINE table 304 contains one record for each item sold, each record comprising the transaction key reference 3045 in the transaction key reference field (kdoc) and further comprising the item ID of one of the items sold. In this example, four items were sold including item x001, item x002, item x003, and item x004. As a further example, FIG. 3 also illustrates another transaction having transaction key reference 3047 in which two items x001 and x004 were sold from enterprise X to its customer “C”.

As generally described in Ser. No. 11/016,087, supra, one type of upsell information request identifies an upsell item for a particular enterprise and requests pairwise, customerwise correlation metrics between the other items sold by the enterprise and the upsell item. By customerwise basis, it is meant that correlations are drawn between two items if they were purchased by the same customer. It is not necessary that they be purchased during the same transaction. A customerwise basis can be contrasted with a transaction-wise basis, in which correlation between two items is drawn only if they were purchased in the same transaction. Pairwise correlation refers to a correlation between two items. Pairwise correlations can be contrasted with higher-dimensional correlations, e.g., in terms of three or more items purchased by the same customer. For two items P and Q, a pairwise, customerwise correlation metric corr(PQ) corresponds to the percentage of customers buying P that also bought Q. For each correlation metric, any of a variety of statistical reliability measures can be associated. In a web-based business application, one particularly convenient statistical reliability measure comprises, for a correlation metric between two items, a direct count of the number of customers who actually did buy both of those items. Preferably, the correlation metrics are computed for transactions occurring over a known time period, as described further infra.

Computationally, for two items P and Q, a correlation corr(PQ) can be derived jointly from the TRANDOC table 302 and the TRANLINE table 304 according to the relationship of Eq. (1) below:

$$corr ( PQ ) = \frac{count ( number\_customers [ bought\_both \_P \_and \_Q ] )}{count ( number\_customers [ bought\_P ] )} \qquad \{ 1 \}$$

Another useful upsell metric that can be derived jointly from the TRANDOC table 302 and the TRANLINE table 304 is a lift metric lift(PQ), representing the degree to which the purchase of item P is likely to predict the purchase of item Q, and which is computed by subtracting the percentage of all customers who bought the item P from the percentage of customers buying P that also bought Q. Computationally, lift(PQ) can be computed according to Eq. (2) below:

$$lift ( PQ ) = corr ( PQ ) - \frac{count ( number\_customers [ bought\_P ] )}{count ( number\_customers )} \qquad \{ 2 \}$$

As also described in Ser. No. 11/016,087, supra, another type of upsell information request identifies a customer of an enterprise and requests, based on previous purchases by that customer, an upsell recommendation listing of items that the identified customer would be likely to buy. This listing can be derived jointly from the TRANDOC table 302 and the TRANLINE table 304. More particularly, each item bought by that customer is identified and, optionally, the number of times that item was bought by that customer is counted. For each bought item the pairwise, customerwise correlation and lift metrics between that bought item and each other item are computed, and those values are used to generate a partial candidate recommendation listing corresponding to that bought item. The partial candidate recommendation listings, one for each bought item, can then be processed to form the ultimate upsell recommendation list. In one preferred embodiment, the partial candidate recommendation listings are thresholded using desired thresholds for correlation and lifts set by the end user, and then concatenated or otherwise joined to form the upsell recommendation list. Any items appearing in the upsell recommendation list that were already bought are preferably filtered out. In another preferred embodiment, the thresholded partial candidate recommendation listings can be ordered in the joined or concatenated listing according to the number of times their associated bought item was purchased by the customer.

Notably, if attempting to compute, in real time, the above upsell metrics using SQL-based commands directly operating on the TRANDOC table 302 and the TRANLINE table 304, bottlenecks can occur at the database server 301 where the volume of data for the collocated combination of enterprises gets excessive, where the traffic of transactions being stored or retrieved at the request of application servers 204 gets too voluminous, or for any of a variety of other reasons. According to a preferred embodiment, at predetermined intervals, the first and second tables TRANDOC 302 and TRANLINE 304 are processed for each enterprise resident thereon to compute additional tables stored in the database 301, termed herein count summary tables and comprising precomputed values from which upsell information requests can be readily accommodated. In this manner, despite substantial volumes of transaction information being received by the database across multiple enterprises, a response to an upsell information request for a particular enterprise can provided quickly while also being generally up-to-date.

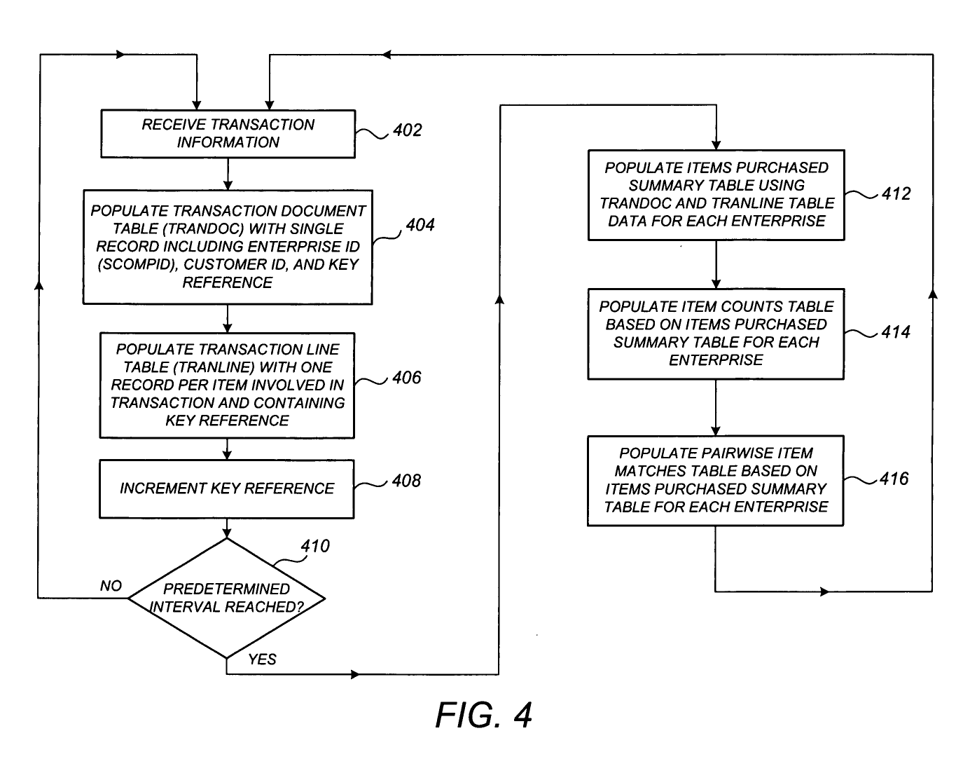

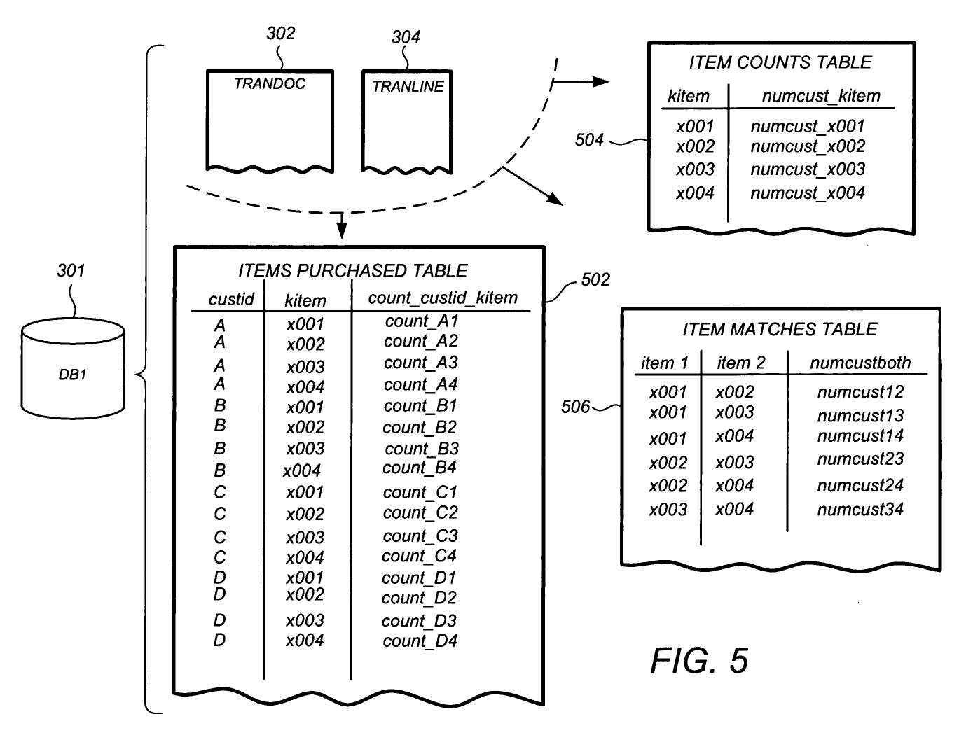

FIG. 4 illustrates populating transaction information tables and count summary tables of a database according to a preferred embodiment. FIG. 5 illustrates count summary tables of a database according to a preferred embodiment. At step 402, transaction information is received by client input. As used herein, client input refers to information received from the enterprise in any of a variety of forms, including not only real-time direct input by enterprise users into their client-side web browsers as transactions occur, but can also refer to a batch-mode or other automated process that transfers transaction information to the web-based business information system. Such batch-mode input forms can be particularly useful for compatibility with legacy systems of the enterprise. Furthermore, in the context of end user input by humans, it is to be appreciated that many of the parameters associated with a transaction, such as enterprise ID, are automatically provided in the context of the web pages and web page requests being sent back and forth, and are not required to correspond to manual inputs by the human end user. At steps 404-408, the TRANDOC table 302 and TRANLINE table 304 are populated as described supra with respect to FIG. 3.

If a predetermined interval is reached (step 410), then at step 412 an items purchased table 502 is populated (i.e., the data is computed and the values created or refreshed) using data from the TRANDOC table 302 and the TRANLINE table 304 for each enterprise. At steps 414 and 416, an item counts table 504 and an item matches table 506, respectively, are populated based on the items purchased table 502. Preferably, the tables 502-506 each span all enterprises associated with the database 301, with an enterprise ID that is associated with each record thereof being omitted from FIG. 5 for clarity.

The items purchased table 502 summarizes, for each customer of the enterprise, a number of purchases of each item sold by the enterprise (e.g., “count_B2” represents the number of times the customer B bought item x002). The item counts table 504 summarizes, for each of the items, a number of customers having purchased that item from the enterprise (e.g., “numcust_x002” represents the number of different customers of the enterprise that bought item x002). The item matches table 506 summarizes, for each possible pairing of the items, a number of customers having purchased both of said items from the enterprise (e.g., “numcust23” represents the number of different customers of the enterprise that bought both items x002 and x003). The items purchased table 502, item counts table 504, and item matches table 506, referred to as count summary tables herein, contain data directly usable in Eqs. (1) and (2) without requiring time intensive operations on the transaction summary tables such that real-time response capability is facilitated for the above-described upsell information requests.

In one preferred embodiment, the predetermined intervals between which the count summary tables are computed are about 24 hours in duration. It has been found that such computation at 24-hour intervals provides a good balance, for most implementations, between the timewise relevance of the provided upsell information and the computational loading of the database 301, which can experience relatively high computational loading when computing the count summary tables. Many enterprise customers experience 24-hour peak-and-valley cycles in both their transactions and their requests for upsell information, such as peaks during the day and valleys during the night, with computation of the count summary tables being particularly advantageous at night. However, the scope of the preferred embodiments is not so limited. In other preferred embodiments, the interval between computations of the count summary tables can be a predefined parameter chosen by each enterprise, or can be predefined on a per-database basis by the ASP host (i.e., applicable for all enterprise accounts on that database). In still other preferred embodiments, the interval can be automatically and dynamically ascertained according to database server loading histories and/or current loading conditions on a per-database basis to be performed during loading valleys. In even other preferred embodiments, there may be an option to for the count summary tables to be updated after a certain number of transactions are received.

As mentioned supra, another time period associated with the count summary tables is the historical interval over which the customer purchasing behavior is analyzed, i.e., the historical interval over which the counts in the count summary tables is taken. In one preferred embodiment having a particular advantage of simplicity, this historical interval can simply be preselected as “since the beginning of time,” i.e., using all available transaction data up to the point at which the count summary tables are computed. In other preferred embodiments, the historical interval can be preselected by each enterprise, or defined on a per-database basis by the ASP host. In still other preferred embodiments, the historical interval can be selected from the group consisting of: one week; one month; one quarter; one year; and the period between (i) the earliest implementation date for each enterprise on the web-based business application and (ii) the current time at which the count summary tables are computed.

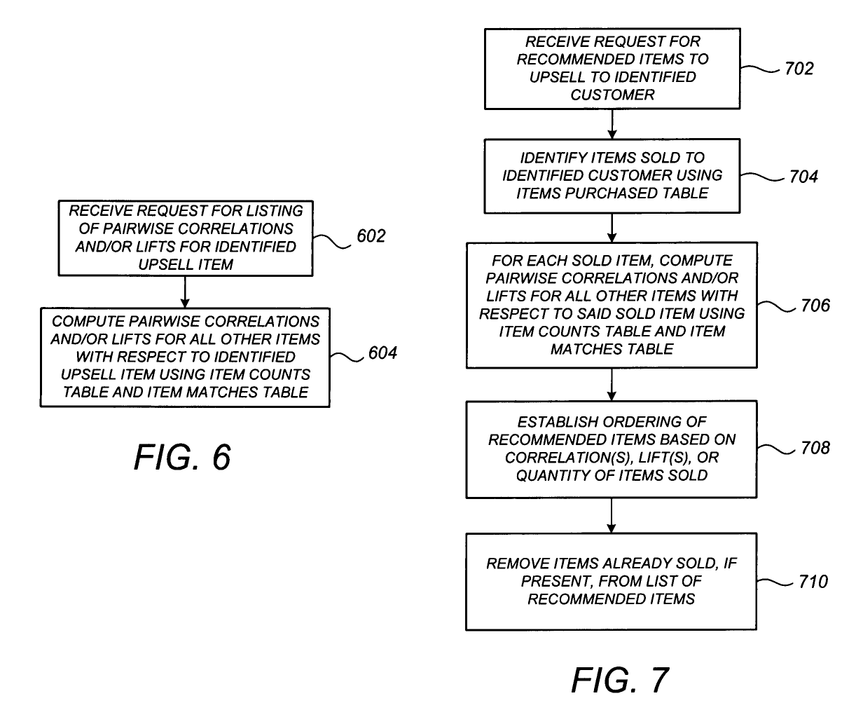

FIG. 6 illustrates receiving and responding to a first kind of upsell information request according to a preferred embodiment. At step 602, an upsell information request is received identifying an upsell item for a particular enterprise and requests pairwise, customerwise correlation metrics (e.g., corro, supra) between the other items sold by the enterprise and the upsell item. At step 604, the requested metrics are computed using the item counts table 504 and the item matches table 506.

FIG. 7 illustrates receiving and responding to a second kind of upsell information request according to a preferred embodiment. At step 702, an upsell information request is received identifying a particular customer of an enterprise and requesting an upsell recommendation list for that customer. At step 704, each item bought by that customer is identified and, optionally, the number of times that item was bought by that customer is counted. At step 706, for each bought item the pairwise, customerwise correlation and lift metrics between that bought item and each other item sold by the enterprise are computed using the using the item counts table 504 and the item matches table 506.

At step 708, an ordering of recommend upsell items is computed based on the metrics computed at step 706 and, optionally, based on the number of times each item was bought by the identified customer according to the items purchased table 502. More particularly, a partial candidate recommendation listing corresponding to each bought item is generated, and then the collection of partial candidate recommendation listings are processed to form the desired upsell recommendation list. Preferably, the partial candidate recommendation listings are thresholded using user-entered thresholds for the correlations and lifts and then concatenated or otherwise joined to form the upsell recommendation list. In another preferred embodiment, the thresholded partial candidate recommendation listings can be ordered in the joined or concatenated listing according to the number of times their associated bought item was purchased by the customer according to the items purchased table 502. At step 710, any items appearing in the upsell recommendation list that were already bought are preferably filtered out.

In an alternative preferred embodiment to that of FIG. 7, the upsell recommendation list for each customer is precomputed at regular intervals, such as the predetermined intervals described supra in relation to FIG. 4 and step 410 thereof, rather than in real-time responsive to a user request for the upsell recommendation list. Accordingly, when such user request is received, the upsell recommendation list is immediately available to the user. In one preferred embodiment, default threshold values for the correlations and lifts on an ASP-wide basis can be used when precomputing the upsell recommendation lists for the customers of each enterprise. In other preferred embodiments, those threshold values can be pre-selected by each enterprise, either on a per-customer basis or an enterprise-wide basis. In still other preferred embodiments, those threshold values can be omitted or set to zero. In the latter case, the resulting upsell recommendation lists will be generally long, but still useful as the end users will be interested in relative rankings near the top of that list.

Whereas many alterations and modifications of the present invention will no doubt become apparent to a person of ordinary skill in the art after having read the foregoing description, it is to be understood that the particular embodiments shown and described by way of illustration are in no way intended to be considered limiting. By way of example, although one or more preferred embodiments supra are described in terms of periodic distillation of the transaction information into the item counts and item matches tables, in other preferred embodiments the item counts and item matches tables can be maintained in real time as each set of transaction information is received. By way of further example, although pairwise item correlations represent one preferred embodiment particularly useful for the web-based business information system setting, in other preferred embodiments higher-dimensional item correlations can be performed that are supersets of the pairwise item correlations.

By way of still further example, the preferred embodiments also include scenarios in which the items of an enterprise are grouped together into logical groupings, with upsell information being provided on a group-to-item and/or group-to-group basis. For example, with reference to FIGS. 3 and 5, supra, the items x001 and x002 may be hard disk drives of two different capacities assigned to a group “g1=hard disks” by enterprise X, while the items x003 and x004 may be microprocessors of two different clock values assigned to a group “g2=processors”. In such scenario, each transaction is recorded across a first table analogous to TRANDOC and a second table analogous to TRANLINE. However, while the customer ID and the transaction key reference are recorded in a single record the first table in the manner described supra, the second table comprises a more general “item/group” field, and more than one record may be populated in the second table for each item sold depending on whether the item is in a group. More particularly, for each item sold in the transaction, the second table comprises (i) a first record containing the transaction key reference in a transaction key field and the item ID in the item/group field, and (ii) if that item belongs a group of items, a second record containing the transaction key reference in the transaction key field and the group ID in the item/group field. At predetermined intervals, the first and second tables are processed to compute third and fourth tables, the third table being analogous to the item counts table 504 and the fourth table being analogous to the item matches table 506. The third table summarizes (i) for each item sold, the count of customers having purchased that item, and (ii) for each item group, the count of customers having purchased an item from that item group. The fourth table summarizes, for each appropriate pairing of the items and the item groups with each other, the count of customers having purchased from both members of that pairing. Responsive to an upsell information request, correlations and lifts among the items and item groups are computed and processed in a manner analogous to the previously described embodiments, with appropriate modifications in the processing for obvious redundancies (e.g., excluding correlations/lifts involving an item and its own item group, which would always be 100% anyway). Thus, reference to the details of the preferred embodiments are not intended to limit their scope, which is limited only by the scope of the claims set forth below

What is claimed is:

1. A method for facilitating upselling in a web-based business application used by an enterprise, the enterprise having a plurality of customers, the enterprise executing one or more transactions with each customer in which one or more items is sold, comprising:
receiving information at a database server for each of the executed transactions, the information including a customer identifier and an item identifier for each item sold in the executed transaction, said database server storing said information across at least two tables including a first table and a second table for each of said executed transactions;
processing said first and second tables at said database server at predetermined intervals of generally long duration compared to intervals between said executed transactions to compute third and fourth tables, said third table summarizing, for each item, a number of customers having purchased that item from the enterprise, said fourth table summarizing, for each possible pairing of said items, a number of customers having purchased both of said items from said enterprise;
receiving a first request at said database server for a plurality of pairwise, customerwise correlation metrics between an upsell item sold by the enterprise and each other item sold by the enterprise; and
computing, responsive to said first request and in real time, said plurality of pairwise, customerwise correlation metrics using said third and fourth tables.

2. The method of claim 1, said processing said first and second tables further comprising computing a fifth table summarizing, for each customer of the enterprise, a number of purchases of each item sold by the enterprise, the method further comprising:
receiving a second request at said database server for an upsell recommendation list corresponding to an identified customer; and
responsive to said request and in real time, performing the steps of:
identifying the items bought by said identified customer using said fifth table;
for each bought item, computing a plurality of pairwise, customerwise correlation and lift metrics between said bought item and each other item using said third and fourth tables, wherein a partial candidate recommendation listing is formed for each bought item; and
processing said partial candidate recommendation listings to form said upsell recommendation list.

3. The method of claim 2, wherein said processing said partial candidate recommendation listings comprises:
thresholding each of said partial candidate recommendation listings based on a predetermined correlation threshold and a predetermined lift threshold;
joining said thresholded partial candidate recommendation listings to form said upsell recommendation list; and
filtering out said bought items therefrom.

4. The method of claim 3, wherein said thresholded partial candidate recommendation listings are ordered according to a number of times the bought item associated therewith was purchased by the identified customer.

5. The method of claim 1, wherein said database server is associated with a plurality of distinct enterprises, wherein said first table comprises a unique transaction ID field, an enterprise ID field, and a transaction key field and contains a single record for each of said executed transactions, wherein said second table comprises said transaction key field and an item identifier field and contains a distinct record for each item purchased in each said executed transaction, and wherein said processing said first and second tables at said database server is performed for each of said distinct enterprises at said predetermined intervals.

6. The method of claim 1, said web-based business application comprising a web server layer, an application server layer, and a database server layer, said database server being contained in said database server layer, said first request received by said database server being received from an application server contained in said application server layer, said application server forming said first request responsive to an input from an enterprise user at a web browser, said input being received at web server contained in said web server layer and being communicated to said application server.

7. The method of claim 1, wherein said predetermined intervals are roughly 24 hours in duration, whereby a real-time response to said first request is quickly achieved while also being up-to-date to within 24 hours of said first request.

8. The method of claim 1, wherein said processing said first and second tables at said database server is performed for transactions executed within a preselected historical time period prior to said processing said first and second tables.

9. The method of claim 8, wherein said preselected historical time period has a duration selected from the group consisting of one week, one month, one quarter, and one year.

10. The method of claim 6, wherein said preselected historical time period extends to an earliest implementation date of said enterprise with respect to said web-based business application.

11. In a database server supporting multiple enterprises served by a web-based business application, each enterprise having a plurality of customers to which one or more items is sold, a method for providing upsell information, comprising:
maintaining a first table summarizing, for each enterprise and each item sold by said enterprise, a first count of customers of said enterprise having purchased that item;
maintaining a second table summarizing, for each enterprise and each pairwise combination of items sold by said enterprise, a second count of customers of said enterprise having purchased both of said items;
receiving a request for a plurality of pairwise, customerwise correlation metrics between an upsell item sold by an identified one of said enterprises and each of the other items sold by said identified enterprise; and
computing, responsive to said request and in real time, said plurality of pairwise, customerwise correlation metrics using said first and second tables.

12. The method of claim 1 1, each enterprise selling their respective items to their customers in one or more transactions therewith, the method further comprising:
receiving information for each said transaction substantially as said transaction occurs, the information including an enterprise identifier and a customer identifier, the information further including, for each item sold in said transaction, an item identifier; and
storing said information for each said transaction across at least two tables including a third table and a fourth table, said third table consisting of a single record for each said transaction, said fourth table consisting of a number of records corresponding to a number of items sold in each said transaction.

13. The method of claim 12, further comprising processing said third and fourth tables at predetermined intervals of generally long duration compared to intervals between said transactions to compute said first and second tables.

14. The method of claim 13, wherein said predetermined intervals are roughly 24 hours in duration, whereby a real-time response to said request is quickly achieved while also being up-to-date to within 24 hours of said request.

15. The method of claim 13, wherein said processing said third and fourth tables is performed for transactions executed within a preselected historical time period prior to said processing said third and fourth tables.

16. The method of claim 15, wherein said preselected historical time period has a duration selected from the group consisting of: one week; one month; one quarter; one year; and a period between (i) an earliest implementation date for each of said enterprises with respect to said web-based business application and (ii) said processing said third and fourth tables.

17. The method of claim 12, further comprising updating said first and second tables as said information for each of said transactions is received.

18. A method for facilitating upselling in a web-based business application used by a plurality of enterprises, each enterprise having a plurality of customers, each enterprise executing one or more transactions with each customer in which one or more items is sold, comprising:
receiving a client input for each of said transactions, said client input communicating an enterprise ID and a customer ID associated with each transaction, said client input further communicating, for each item sold in each transaction, an item ID;
storing said enterprise ID, said customer ID, and a transaction key reference in a single record of a first table of a database, said database being common to at least two of said enterprises including the enterprise associated with said enterprise ID;
storing said transaction key reference and each of said item IDs for each transaction across a number of records of a second table of said database corresponding to a number of items sold in that transaction;
processing, at predetermined intervals, said first and second tables of said database to compute third and fourth tables thereof, said third table summarizing, for each enterprise and for each item sold by that enterprise, a first count of customers having purchased that item from that enterprise, said fourth table summarizing, for each enterprise and each possible pairing of items sold by that enterprise, a second count of customers having purchased both such items from that enterprise;
receiving a first upsell query identifying a first enterprise associated with said database and identifying an upsell item;
responsive to said first upsell query, computing a plurality of pairwise, customerwise correlation metrics between said upsell item and each other item sold by said first enterprise, said computing being performed in real time using said third and fourth tables of said database previously computed at said predetermined intervals.

19. The method of claim 18, said processing said first and second tables further comprising computing a fifth table summarizing, for each customer of each enterprise associated with said database, a number of purchases of each item sold by that enterprise, the method further comprising:
receiving a second upsell query, said second upsell query identifying a second enterprise associated with said database and identifying a customer of said second enterprise; and
responsive to said second upsell query and in real time, performing the steps of:
identifying items bought from said second enterprise by said identified customer using said fifth table;
for each bought item, computing a plurality of pairwise, customerwise correlation and lift metrics between each other item sold by the second enterprise and said bought item using said third and fourth tables, wherein a partial candidate recommendation listing is formed for each bought item; and
processing said partial candidate recommendation listings to form said upsell recommendation list for said identified customer of said second enterprise.

20. The method of claim 19, wherein said processing said partial candidate recommendation listings comprises:
thresholding each of said partial candidate recommendation listings based on a predetermined correlation threshold and a predetermined lift threshold; and
joining said thresholded partial candidate recommendation listings to form said upsell recommendation list; and
filtering out said bought items therefrom.

21. The method of claim 20, wherein said thresholded partial candidate recommendation listings are ordered according to a number of times the bought item associated therewith was purchased by the identified customer.

22. The method of claim 18, wherein said predetermined intervals are roughly 24 hours in duration, whereby a real-time response to said first upsell query is quickly achieved while also being up-to-date to within 24 hours of business transactions.

23. The method of claim 18, wherein said processing said first and second tables is performed for transactions executed within a preselected historical time period prior to said processing said first and second tables.

24. The method of claim 23, wherein said preselected historical time period has a duration selected from the group consisting of: one week; one month; one quarter; one year; and a period between (i) an earliest implementation date for each of said enterprises with respect to said web-based business application and (ii) said processing said first and second tables.

25. A method for facilitating upselling in a web-based business application used by an enterprise, the enterprise having a plurality of customers and a plurality of items, the enterprise further having a plurality of item groups into which at least one of said items is classified, the enterprise executing one or more transactions with each customer in which one or more of the items is sold, comprising:
receiving a client input for each of said transactions, said client input communicating a customer ID associated with each transaction, said client input further communicating, for each item sold in each transaction, an item ID;
storing said customer ID and a transaction key reference in a single record of a first table of a database for each of said transactions;
storing one or more records in a second table of said database for each of said transactions, said second table comprising a transaction key field and an item/group field, said one or more records including, for each item sold in said transaction, (i) a first record containing said transaction key reference in said transaction key field and said item ID in said item/group field, and (ii) if said item belongs to one of said item groups, a second record containing said transaction key reference in said transaction key field and a group ID corresponding to said item group in said item/group field;
processing, at predetermined intervals, said first and second tables of said database to compute third and fourth tables thereof, wherein said third table summarizes (i) for each item sold, a first count of customers having purchased that item, and (ii) for each item group, a second count of customers having purchased an item from said item group, and wherein said fourth table summarizes, for each appropriate pairing of said items and item groups with each other, a third count of customers having purchased from both members of said pairing;
receiving a user upsell query identifying an upsell item or an upsell item group; and
responsive to said user upsell query, computing a plurality of pairwise, customerwise correlation metrics between each appropriate pairing of said upsell item or upsell item group with each other item and item group, said computing being performed in real time using said third and fourth tables of said database previously computed at said predetermined intervals.

26. The method of claim 25, wherein said predetermined intervals are roughly 24 hours in duration, whereby a real-time response to said request is quickly achieved while also being up-to-date to within 24 hours of said request.

27. The method of claim 25, wherein said processing said first and second tables is performed for transactions executed within a preselected historical time period prior to said processing said first and second tables.

28. The method of claim 27, wherein said preselected historical time period has a duration selected from the group consisting of: one week; one month; one quarter; one year; and a period between (i) an earliest implementation date for each of said enterprises with respect to said web-based business application and (ii) said processing said first and second tables.
